(19) United States
(12) Patent Application Publication
(10) Pub. No.: US 2003/0194105 A1
(43) Pub. Date: Oct. 16, 2003

(54) Speaker for an electronic instrument

(75) Inventors: Atsushi Kuwabara, Yamanashi-ken (JP); Yoshizumi Ohta, Yamanashi-ken (JP)

Correspondence Address: DENNISON, SCHULTZ & DOUGHERTY, Suite 612, 1745 Jefferson Davis Highway, Arlington, VA, 22202, US

(73) Assignee: Citizen Electronics Co., Ltd.

(21) Appl. No.: 10/409,081

(22) Filed: Apr. 9, 2003

(30) Foreign Application Priority Data
Apr. 10, 2002 (JP) 2002-107222

(51) Int. Cl. H04R 1/00; H04R 9/06; H04R 11/02

(52) U.S. Cl. 381/409; 381/398; 381/433; 381/396; 381/410

(57) ABSTRACT

A speaker has a frame made of resin, a diaphragm provided in the frame, a voice coil mounted on the diaphragm. A pair of holes are formed under the diaphragm so as to be opened at an underside of the frame. A spring is connecting member provided in each of the holes to be projected from the underside of the frame, and connected to an end of the voice coil.

### BACKGROUND OF THE INVENTION

The present invention relates to a speaker for generating sounds by vibrating a diaphragm.

In recent years, there is a tendency to mount small electric parts on a printed circuit board, an electrodynamic speaker for the small electronic instrument is accordingly mounted on the printed circuit board. Such a printed circuit for the portable telephone is used as a signaling device.

Referring to FIGS. 5 and 6, which are a plan view of a conventional electrodynamic speaker and a sectional view taken along a line VI-VI of FIG. 5, respectively, an electrodynamic speaker 50 has a circular frame 51 having a central circular hole 51a and a pair of projection portion 51d. An annular shoulder 51b is formed on the frame 51 and a cylindrical hole 5le is formed in each of the projection portions 5d.

A yoke 52 made of magnetic material and having a dish-shape is secured to the wall of the central hole 51a. A disk-shape magnet 53 is secured to the yoke 52 and a disk-shape top plate 54 is securely mounted on the magnet 53. Thus, a magnetic circuit is formed between the yoke 52 and the top plate 54, interposing the magnet 53.

A circular diaphragm 55 made of plastic has a spherical central portion, and a circular recess 55a at the periphery of the central portion. An annular voice coil 56 is fixed to the underside of the recess 55a and inserted in the gap between the periphery of the top plate 54 and an upper portion of the yoke 52.

A pair of lead plates 57, each of which is made of an elongated metal plate, are embedded in the frame 51. An end of each of the lead plates 57 is connected to the voice coil 56, the other end is inserted in the hole 51e of the projection portion 51d. A coil spring 58 is inserted in each hole 51e. An upper end 58a of the coil spring 58 is inserted in a hole formed in an end portion 57a of the lead plate 57 and electrically connected to the lead plate 57 by solder. The lower end of the spring 58 is projected from the underside of the frame 51.

Both ends of the coil 56 are soldered to ends of lead plates 57. Thus, the coil 56 is connected to the coil springs 58.

A cover 59 has sound emanating holes 59a and is adhered to the shoulder 51b. The coil springs 58 are pressed against a circuit pattern on a substrate.

In the conventional speaker, since the projection portions 51d are projected from the frame 51, the speaker occupies a larger area. Thus, the projection prevents the speaker from being miniaturized.

### SUMMARY OF THE INVENTION

An object of the present invention is to provide a speaker having a small area in plan view.

According to the present invention, there is provided a speaker comprising a frame made of resin, a diaphragm provided in the frame, a voice coil mounted on the diaphragm, a pair of holes formed under the diaphragm so as to be opened at an underside of the frame, and a connecting member provided in each of the holes to be projected from the underside of the frame, and connected to an end of the voice coil.

The connecting member is a spring.

The frame comprises an upper frame and a lower frame, the upper frame has a holding portion extending to an underside of the lower frame, and the holes are formed in the holding portion.

These and other objects and features of the present invention will become more apparent from the following detailed description with reference to the accompanying drawings.

### BRIEF DESCRIPTION OF DRAWINGS

FIG. 1 is a plan view of a speaker of the present invention;

FIG. 2 is a sectional view of the speaker taken along a line II-II of FIG. 3;

FIG. 3 is a plan view of the speaker as viewed from the underside thereof;

FIG. 4 is a sectional view for explaining the assembling of the speaker;

FIG. 5 is a plan view of a conventional electrodynamic speaker;

FIG. 6 is a sectional view taken along a line VI-VI of FIG. 5; and

FIG. 7 is a plan view as viewed from the underside thereof.

### DETAILED DESCRIPTION OF THE PREFERRED EMBODIMENT

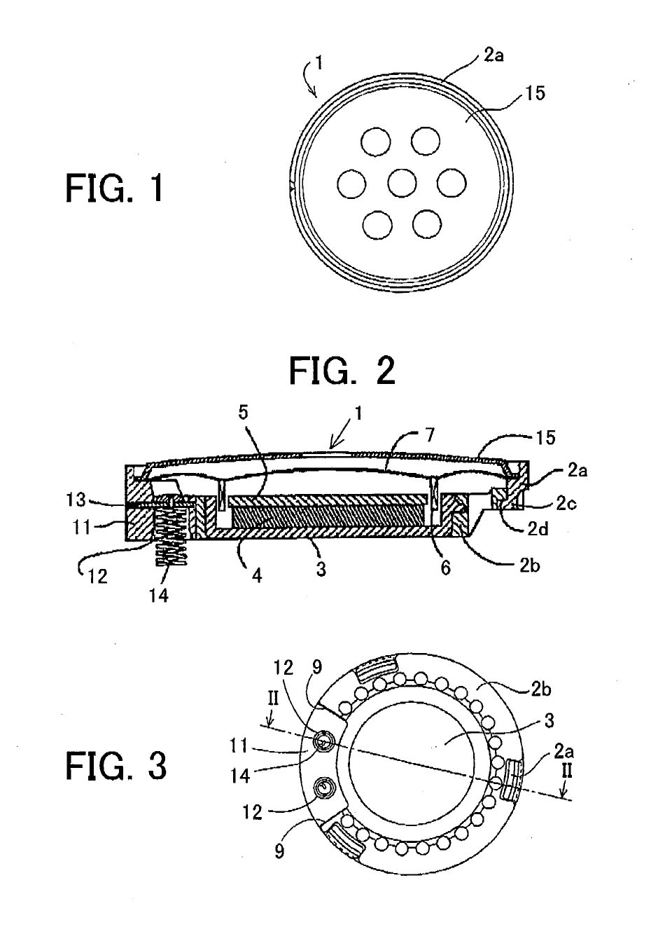

Referring to FIGS. 1 to 3, an electrodynamic speaker 1 has a circular frame 2 made of plastic and comprising an upper frame 2a and a lower frame 2b, The upper frame 2a has a shoulder 2c and the lower frame 2b has a hook 2d, and both frames are adhered at the shoulder 2c and hook 2d.

A yoke 3 made of magnetic material and having a dish-shape is secured to the lower frame 2b. A disk-shape permanent magnet 4 and a disk-shape top plate 5 are stacked on the yoke 3 and secured to each other.

A circular diaphragm 7 made of plastic has a spherical central portion, a circular recess at the periphery of the central portion and a peripheral portion. An annular voice coil 6 is fixed to the underside of the recess and inserted in the gap between the periphery of the top plate 5 and an upper portion of the yoke 3.

The upper frame 2a has a downwardly projected holding portion 11 which is disposed in a recess 9 formed in the lower frame 2b and extended to the same plane as the underside of the lower frame 2b as shown in FIG. 2 and has a semicircular shape in plan view as shown in FIG. 3. In the holding portion 11, a pair of insertion holes 12 are axially formed to be opened at the underside of the holding portion.

A pair of lead plates 13, each of which is made of an elongated metal plate, are embedded in the frame 2. A coil spring 14 is inserted in each hole 12. An upper end of the coil spring 14 is inserted in a hole formed in an end portion of the lead plate 13 and electrically connected to the lead plate 13 by solder. The lower end of the spring 14 is projected from the underside of the frame 2.

Both ends of the voice coil 6 are soldered to ends of lead plates 13. Thus, the coil 6 is connected to the coil springs 14. A cover 15 has sound emanating holes and is adhered to a shoulder of the frame 2 together with the diaphragm 7. The coil springs 14 are pressed against a circuit pattern on a substrate.

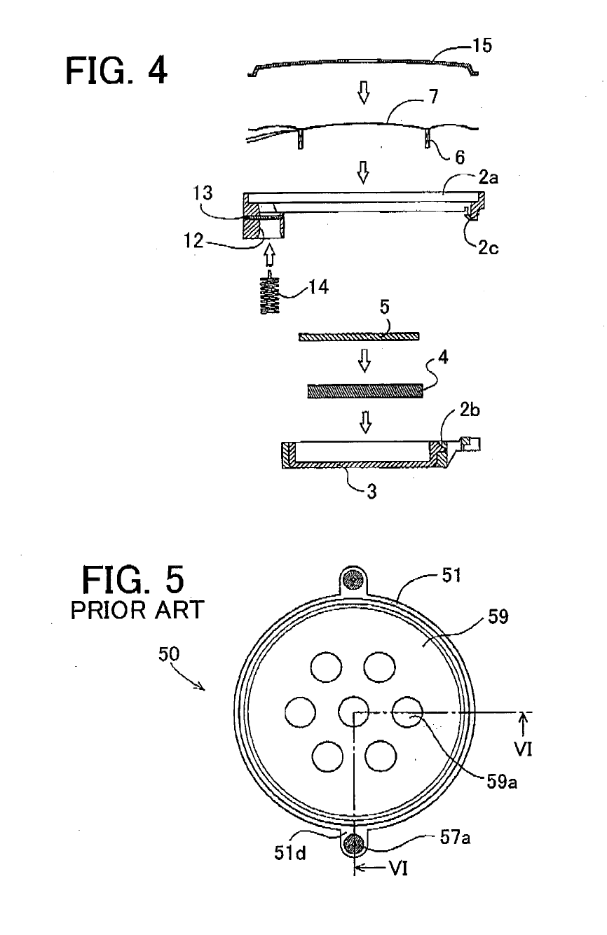

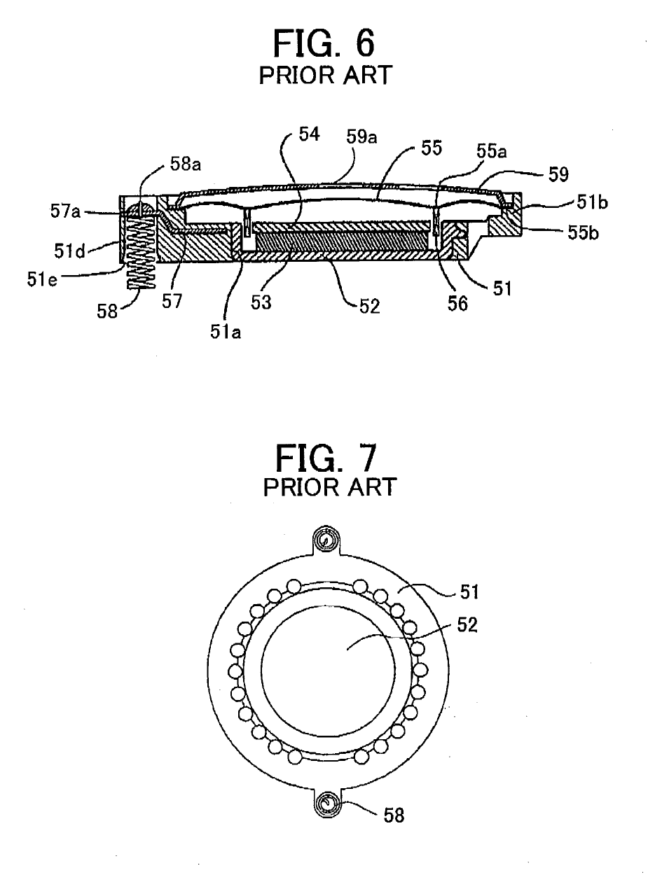

The method for assembling the speaker is described hereinafter with reference to FIG. 4. The lead plate 13 is preliminarily embedded in the upper frame 2a. The diaphragm 7 to which a voice coil 6 is secured is fixed to the upper frame, on which the cover 15 is adhered. Next, both ends of the voice coil 6 are soldered to exposed ends of the lead plates 13. Each coil spring 14 is inserted in the insertion hole 12, and the end of the spring 14 is soldered to the end of the lead plate.

The yoke 3 is embedded in the lower frame 2b. The permanent magnet 4 is adhered to the yoke, and the top plate 5 is adhered to the magnet 4. Lastly, the upper and lower frames are secured at the shoulder 2c and hook 2d.

In accordance with the present invention, there is not provided projection portions outwardly projected from the frame of the speaker. Therefore, the speaker does not occupy a large area, thereby reducing the size of an electronic instrument to be provided with the speaker.

While the invention has been described in conjunction with preferred specific embodiment thereof, it will be understood that this description is intended to illustrate and not limit the scope of the invention, which is defined by the following claims.

What is claimed is:

1. A speaker comprising:
a frame made of resin;
a diaphragm provided in the frame;
a voice coil mounted on the diaphragm;
a pair of holes formed under the diaphragm so as to be opened at an underside of the frame; and
a connecting member provided in each of the holes to be projected from the underside of the frame, and connected to an end of the voice coil.

2. The speaker according to claim 1 wherein the connecting member is a spring.

3. The speaker according to claim 1 wherein the frame comprises an upper frame and a lower frame, the upper frame has a holding portion extending to an underside of the lower frame, and the holes are formed in the holding portion.
